(19) United States
(12) Patent Application Publication
(10) Pub. No.: US 2025/0206241 A1
(43) Pub. Date: Jun. 26, 2025

(54) ATTACHMENT STRUCTURE OF ELECTRICAL COMPONENT AND MANUFACTURING METHOD OF ATTACHMENT STRUCTURE

(71) Applicant: TOYOTA JIDOSHA KABUSHIKI KAISHA, Toyota-shi (JP)

(72) Inventor: Fumihiko MIZUSAWA, Toyota-shi (JP)

(21) Appl. No.: 18/939,518

(22) Filed: Nov. 7, 2024

(30) Foreign Application Priority Data
Dec. 26, 2023 (JP) 2023-219812

(51) Int. Cl. B60R 16/02

(52) U.S. Cl. CPC B60R 16/02

(57) ABSTRACT

An attachment structure of an electrical component, includes: plural first attachment seating surfaces that are provided at positions at which the electrical component is attached at a vehicle, each of the plural first attachment seating surfaces formed with an attachment hole; and plural second attachment seating surfaces, each of the plural second attachment seating surfaces is formed with a score processing hole on which notch processing has been performed along a shape of a hole to be penetrated, the plural first attachment seating surfaces and the plural second attachment seating surfaces are formed at heights different from a height of other regions.

### CROSS-REFERENCE TO RELATED APPLICATION

This application is based on and claims priority under 35 USC 119 from Japanese Patent Application No. 2023-219812, filed on Dec. 26, 2023, the entire disclosure of which is incorporated by reference herein in its entirety.

### BACKGROUND

### Technical Field

The present disclosure relates to an attachment structure of an electrical component, and a manufacturing method of an attachment structure.

### Related Art

Japanese Patent Application Laid-Open (JP-A) No. 2007-137084 discloses that an electrical component such as antenna feeder wire is fixed to an attachment hole that is provided in a panel material of a roof side portion, for example, using clips. In this manner, when forming the attachment hole for attaching the clip or the component, the processing position of the attachment hole differs according to the vehicle type or specification. Therefore, conventionally, plural attachment holes are formed in consideration of plural vehicle types and specifications, and attachment holes, which are not used for each vehicle, are covered with a cover or the like.

However, in methods in which an unused attachment hole is covered with a cover or the like, installation man-hours and cost are increased by an amount corresponding to the number of covers. On the other hand, score processing is known in which notches are provided at installation positions of attachments holes in accordance with a desired shape of the holes. Attachment holes are formed as necessary by punching out the inside of the holes that have been scored. However, at positions at which no attachment hole is required, score processing is left on and a notch remains, such that strength sometimes decreases, and therefore, there is room for improvement from the perspective of strength.

### SUMMARY

The present disclosure provides an attachment structure of an electrical component and a manufacturing method of an attachment structure, which are capable of suppressing a decrease in strength, while suppressing an increase in installation man-hours and cost.

An attachment structure of an electrical component according to a first aspect of the present disclosure includes: plural first attachment seating surfaces that are provided at positions at which the electrical component is attached at a vehicle, each of the plural first attachment seating surfaces formed with an attachment hole; and plural second attachment seating surfaces, each of the plural second attachment seating surfaces is formed with a score processing hole on which notch processing has been performed along a shape of a hole to be penetrated, wherein the plural first attachment seating surfaces and the plural second attachment seating surfaces are formed at heights different from a height of other regions.

In the attachment structure of an electrical component according to the first aspect of the present disclosure, an attachment hole is formed at a first attachment seating surface that is provided at a position at which an electrical component is attached at a vehicle, and a score processing hole, on which notch processing has been performed along a shape of a hole to be penetrated, is formed at a second attachment seating surface. Namely, an attachment hole is formed at a position necessary for attachment of an electrical component at a vehicle, and a score processing hole is formed at a position that is not necessary for attachment of an electrical component at the vehicle. Although notch processing is performed on the score processing hole, the score processing hole does not penetrate through, such that a cover for closing an attachment hole that is not necessary at the vehicle is not necessary. This enables an increase in the installation man-hours and cost required for a cover to be suppressed.

Further, in the attachment structure of an electrical component according to the first aspect of the present disclosure, the first attachment seating surfaces and the second attachment seating surfaces are formed at heights different from a height of other regions. Therefore, stress is dispersed at the second attachment seating surface at which the score processing hole is formed, such that stress concentration at the score processing hole is alleviated, and stress concentration at the score processing hole and cracking can be prevented from occurring. This enables reduction in strength at the score processing hole to be suppressed.

An attachment structure of an electrical component according to a second aspect of the present disclosure is the attachment structure of an electrical component according to the first aspect, wherein the attachment hole is formed by punching out an inside of the score processing hole on which notch processing has been performed along a shape of a hole to be penetrated.

In the attachment structure of an electrical component according to the second aspect of the present disclosure, the attachment hole is formed by punching out the inside of the shape of the hole on which notch processing has been performed, such that the attachment hole can be formed from the score processing hole as necessary.

An attachment structure of an electrical component according to a third aspect of the present disclosure is the attachment structure of an electrical component according to the first aspect or the second aspect, wherein the plural first attachment seating surfaces and the plural second attachment seating surfaces are formed at substantially a same height.

In the attachment structure of an electrical component according to the third aspect of the present disclosure, the plural first attachment seating surfaces and the plural second attachment seating surfaces are formed at approximately the same height, and therefore, by punching out the inside of the score processing holes formed in the second attachment seating surfaces, attachment holes of approximately the same level as the attachment holes formed in the first attachment seating surfaces can be formed at positions at which the second attachment seating surfaces are provided, as necessary.

An attachment structure of an electrical component according to a fourth aspect of the present disclosure is the attachment structure of an electrical component according to at least one of the first aspect to the fourth aspect, wherein attachment holes formed at the plural first attachment seating surfaces, score processing holes formed at the plural second attachment seating surfaces, or any combination thereof, have at least two different shapes.

In the attachment structure of an electrical component according to the fourth aspect of the present disclosure, attachment holes formed at the plural first attachment seating surfaces, score processing holes formed at the plural second attachment seating surfaces, or any combination thereof, have at least two different shapes, such that attachment holes with shapes corresponding to the type of electrical components to be attached can be provided.

A method of manufacturing an attachment structure according to a fifth aspect of the present disclosure includes: forming plural attachment seating surfaces at positions at which an electrical component may be attached at a vehicle, at a height different from a height of other regions; forming, at each of the plural attachment seating surfaces, a score processing hole on which notch processing has been performed along a shape of a hole to be penetrated; and forming attachment holes, by punching out an inside of the score processing holes, at the score processing holes provided at positions at which attachment of the electrical component has been determined.

In the method of manufacturing an attachment structure according to the fifth aspect of the present disclosure, a score processing hole on which notch processing has been performed along a shape of a hole to be penetrated is formed in an attachment seating surface that is formed at a height different from a height of other regions. Although notch processing is performed on the score processing hole, the score processing hole does not penetrate through, such that a cover for closing a hole that is not necessary at the vehicle is not necessary. This enables an increase in the installation man-hours and cost required for a cover to be suppressed. Further, since stress is dispersed at the attachment seating surface, stress concentration at the score processing hole is alleviated, and stress concentration at the score processing hole and cracking can be prevented. Namely, a reduction in strength at the score processing hole can be suppressed.

The attachment structure of an electrical component and the manufacturing method of an attachment structure according to the present disclosure can suppress a decrease in strength, while suppressing an increase in installation man-hours and cost.

### BRIEF DESCRIPTION OF THE DRAWINGS

An exemplary embodiment of the present disclosure will be described in detail based on the following figures, wherein:

FIG. 1 is a perspective view illustrating an example of positions at which setting of a score processing hole is being considered in a body of a vehicle;

FIG. 2 is a bottom view illustrating an example of positions at which setting of a score processing hole is being considered in a roof of a vehicle;

FIG. 3 is an inside side view illustrating an example of positions at which setting of a score processing hole is being considered in a side door of a vehicle;

FIG. 4 is a plan view and a side view illustrating an example of a second attachment seating surface included in an attachment structure of an electrical component according to an exemplary embodiment of the present disclosure;

FIG. 5 is a perspective view illustrating an example of a score processing hole;

FIG. 6 is a cross-section taken along line A-A in FIG. 5;

FIG. 7 is an explanatory diagram illustrating score processing;

FIG. 8 is a plan view and a side view illustrating an example of a first attachment seating surface included in an attachment structure of an electrical component according to an exemplary embodiment of the present disclosure;

FIG. 9 is an explanatory diagram illustrating punching processing;

FIG. 10 is a flowchart illustrating a series of manufacturing processes of an attachment structure of an electrical component according to an exemplary embodiment of the present disclosure;

FIG. 11 is a plan view and a side view illustrating an example of spot welded portion provided at a seating surface;

FIG. 12 is a diagram illustrating an example of a stress distribution of a spot welded portion in a case in which there is no seating surface; and

FIG. 13 is a diagram illustrating an example of a stress distribution of a spot welded portion in a case in which there is a seating surface.

### DETAILED DESCRIPTION

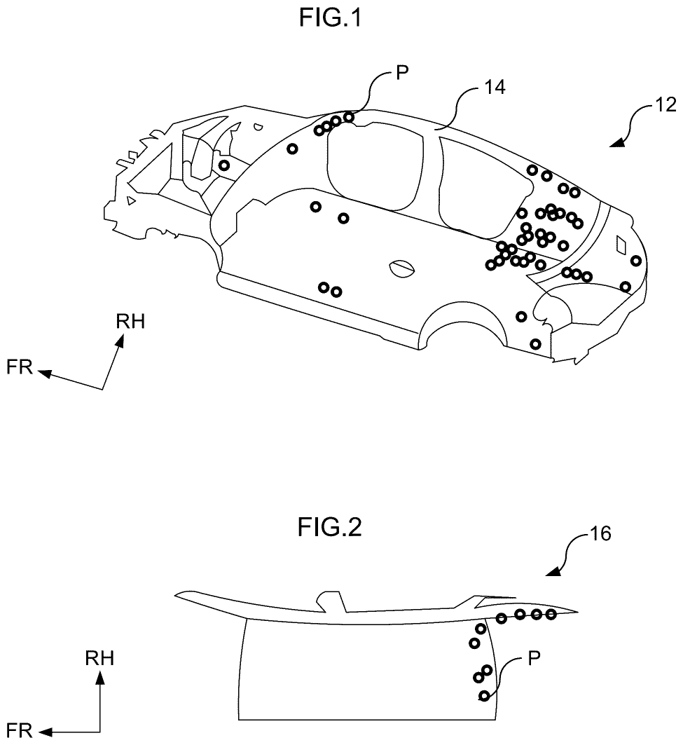

Explanation follows regarding an attachment structure 10 of an electrical component (electrical hardware) according to an exemplary embodiment of the present disclosure, with reference to FIG. 1 to FIG. 9. In the explanation of the drawings, the same reference numerals are used for the same or equivalent elements, and overlapping explanation is omitted.

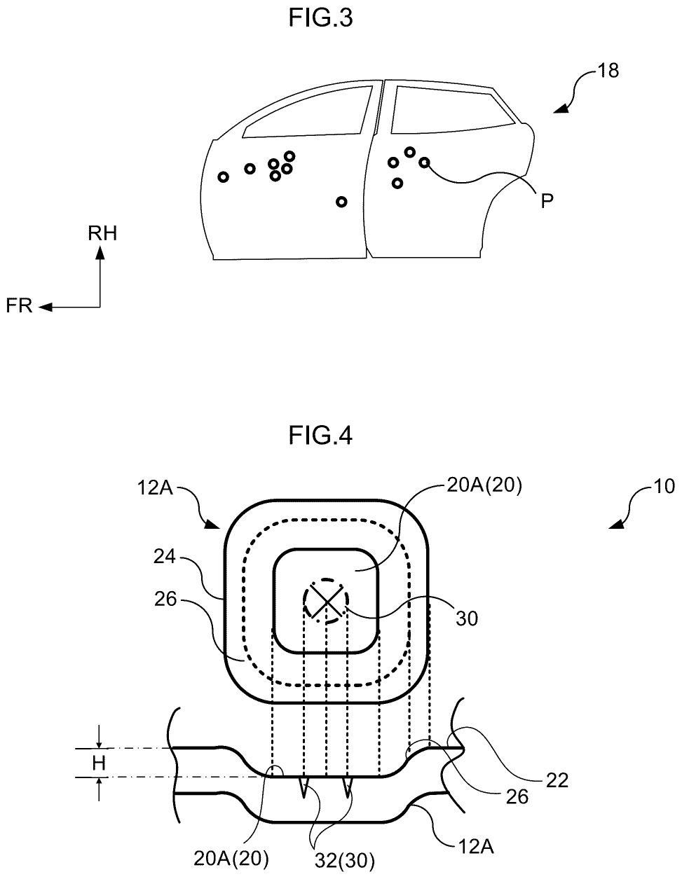

FIG. 1 is a perspective view illustrating an example of positions at which setting of a score processing hole is being considered in a body 14 of a vehicle 12, FIG. 2 is a bottom view illustrating an example of positions at which setting of a score processing hole is being considered in a roof 16 of the vehicle 12, and FIG. 3 is an inside side view illustrating an example of positions at which setting of a score processing hole is being considered in a side door 18 of the vehicle 12. It should be noted that in each of the drawings, as appropriate, the arrow FR indicates a vehicle front direction, and the arrow RH indicates a vehicle right direction.

As illustrated in FIG. 1 to FIG. 3, the attachment structure 10 of an electrical component includes, as an example, plural attachment seating surfaces 20 for forming score processing holes 30, which are described below, at positions P at which an electrical component (not illustrated in the drawings) may be attached, such as in a panel 12A used in the body 14, the roof 16, the side doors 18 and the like of the vehicle 12. It should be noted that in FIG. 1 to FIG. 3, as an example, a position indicated by a circle is a position P at which an electrical component (not illustrated in the drawings) may be attached. As illustrated in FIG. 1 to FIG. 3, in the vehicle 12, the position P is set at any point. In particular, in a hybrid vehicle (hybrid electric vehicle (HEV)), a plug-in hybrid vehicle (plug-in hybrid electric vehicle (PHEV)), a fuel cell vehicle (fuel cell electric vehicle (FCEV)), an electric vehicle (battery electric vehicle (BEV)), or the like, the number of positions P is greater than that of a gasoline vehicle.

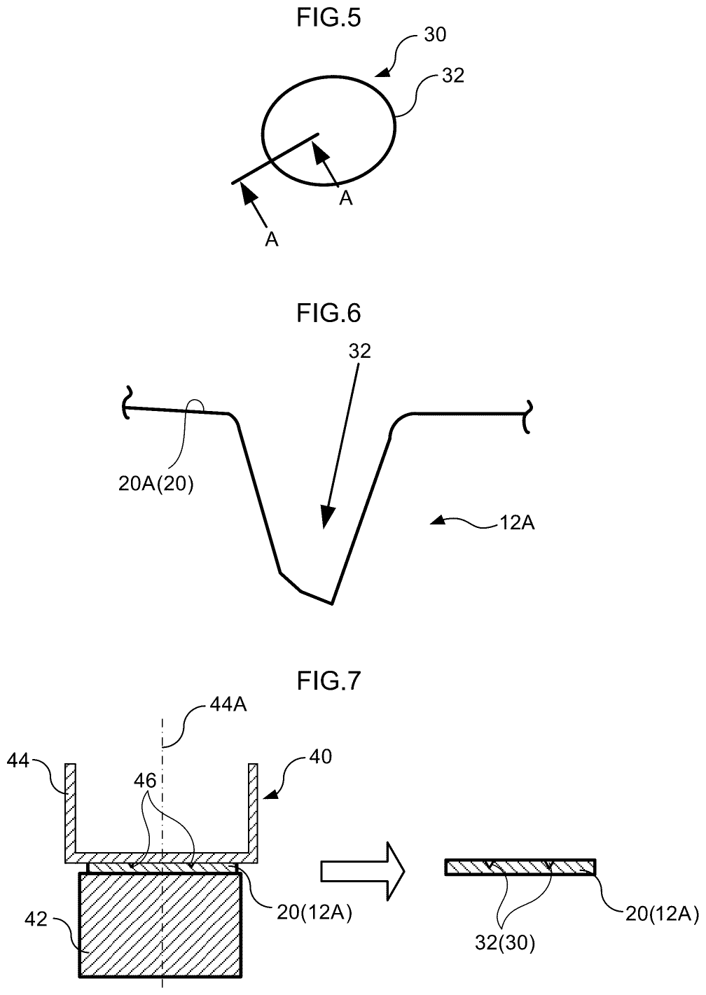

FIG. 4 is a plan view and a side view illustrating an example of the score processing hole 30 formed in a second attachment seating surface 20A, FIG. 5 is a perspective view illustrating an example of the score processing hole 30, and FIG. 6 is a cross-section taken along line A-A in FIG. 5. As illustrated in FIG. 4, as an example, the attachment seating surface 20 is formed in a square shape, and is formed at a height that is different from the height of other regions 22. In the present exemplary embodiment, as an example, the attachment seating surface 20 is formed lower than the other regions 22 by a height H.

Specifically, a square frame 24 that is larger than the attachment seating surface 20 is set so as to surround the attachment seating surface 20. The rectangular frame 24 is set at approximately the same height as the other regions 22, and an inclined portion 26 is provided so as to be smoothly connected from the rectangular frame 24 to the attachment seating surface 20.

A score processing hole 30 is formed at a substantially central portion of the attachment seating surface 20. It should be noted that in the present exemplary embodiment, the attachment seating surface 20 at which the score processing hole 30 is formed is the second attachment seating surface 20A. As illustrated in FIG. 5 and FIG. 6, notch processing is performed on the score processing hole 30 along the shape of the hole to be penetrated. Namely, notches 32 are formed that are cut into a thickness direction of the panel 12A along the shape of the hole. As illustrated in FIG. 6, the notches 32 are formed so as to be sharp.

Explanation follows regarding a process of forming the score processing hole 30 by score processing (also referred to as notch processing). FIG. 7 is an explanatory diagram illustrating score processing.

As illustrated in the left view of FIG. 7, a score processing machine 40 is used for score processing to form the score processing hole 30. It should be noted that any machine may be used as long as the score processing machine 40 is capable of forming the score processing hole 30, and there is no particular limitation thereto. In the present exemplary embodiment, as an example, the score processing machine 40 includes a mold 42 at which the panel 12A is mounted, and a rotatable portion 44 that is positioned above the panel 12A mounted at the mold 42. As an example, the rotatable portion 44 is in the shape of a cylindrical box that is open at the upper side, is capable of moving up and down by a motor (not illustrated in the drawings), and is rotatable about a shaft 44A. A score processing blade 46 is attached to a bottom surface of the rotatable portion 44, and the attachment position of the score processing blade 46 can be changed in accordance with the shape of the score processing hole 30 to be formed.

As illustrated in the right view of FIG. 7, by rotating the rotatable portion 44 with the score processing blade 46 in contact with the attachment seating surface 20 of the panel 12A that is mounted at the mold 42, the score processing hole 30, in which the notch 32 is formed in the shape of a desired hole, is formed. It should be noted that in the present exemplary embodiment, as an example, the score processing holes 30 have two or more types of shapes that differ in size and shape in accordance with the positions P at which the attachment seating surfaces 20 are installed.

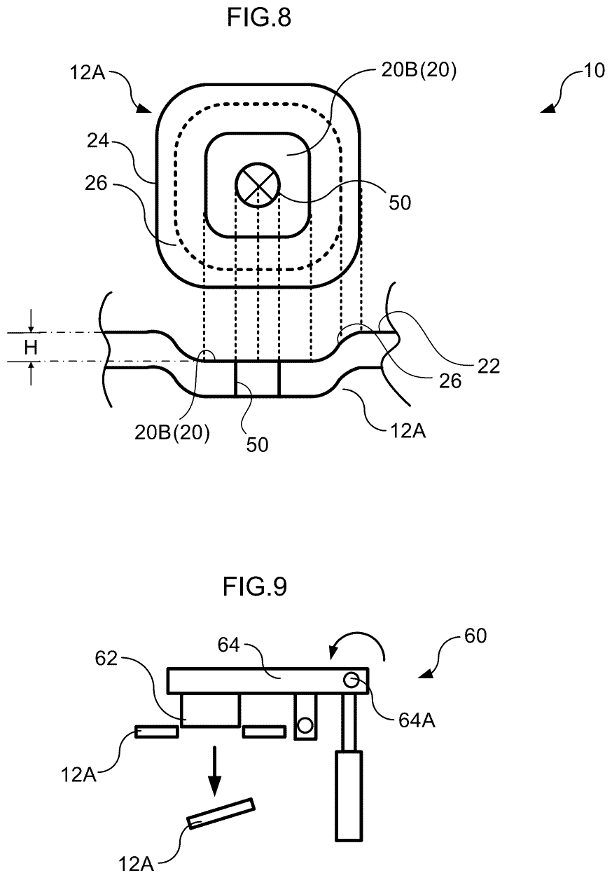

Explanation follows regarding an attachment hole 50. FIG. 8 is a plan view and a side view illustrating an example of the attachment hole 50 that is formed in a first attachment seating surface 20B. As an example, the attachment hole 50 of the present exemplary embodiment is formed by punching out the inside of the score processing hole 30 in the second attachment seating surface 20A in which the processing hole 30 is formed as described above. The attachment seating surface 20, including the attachment hole 50 that is formed in this manner, is the first attachment seating surface 20B. Namely, the second attachment seating surface 20A becomes the first attachment seating surface 20B due to the score processing hole 30 being processed into the attachment hole 50.

Explanation follows regarding punching processing in which the attachment hole 50 is machined by punching out the score processing hole 30. FIG. 9 is an explanatory diagram illustrating punching processing.

As illustrated in FIG. 9, a punching machine 60 is used in punching processing to form the attachment hole 50. It should be noted that any machine may be used as long as the punching machine 60 is capable of punching out the inside of the score processing hole 30, and there is no particular limitation thereto. In the present exemplary embodiment, as an example, the punching machine 60 includes a punching portion 62 that is made of metal, and includes a rotatable portion 64 that is rotatable about a shaft 64A.

The panel 12A including the second attachment seating surface 20A at which the score processing hole 30 is formed is rotated in a state held by a die portion (not illustrated in the drawings), such that the punching portion 62 is rotated, such that the inside of the score processing hole 30 is punched out and penetrated, and the attachment hole 50 is formed. The attachment seating surface 20, including the attachment hole 50 that is formed in this manner, is the first mounting seating surface 20B. It should be noted that in the present exemplary embodiment, as an example, the score processing holes 30 have two or more types of shapes that differ in size and shape in accordance with the positions P at which the attachment seating surfaces 20 is installed, such that when the attachment holes 50 are formed from the score processing holes 30, the attachment holes 50 may similarly have two or more types of shapes that differ in size and shape in accordance with the positions P at which the attachment seating surfaces 20 are installed.

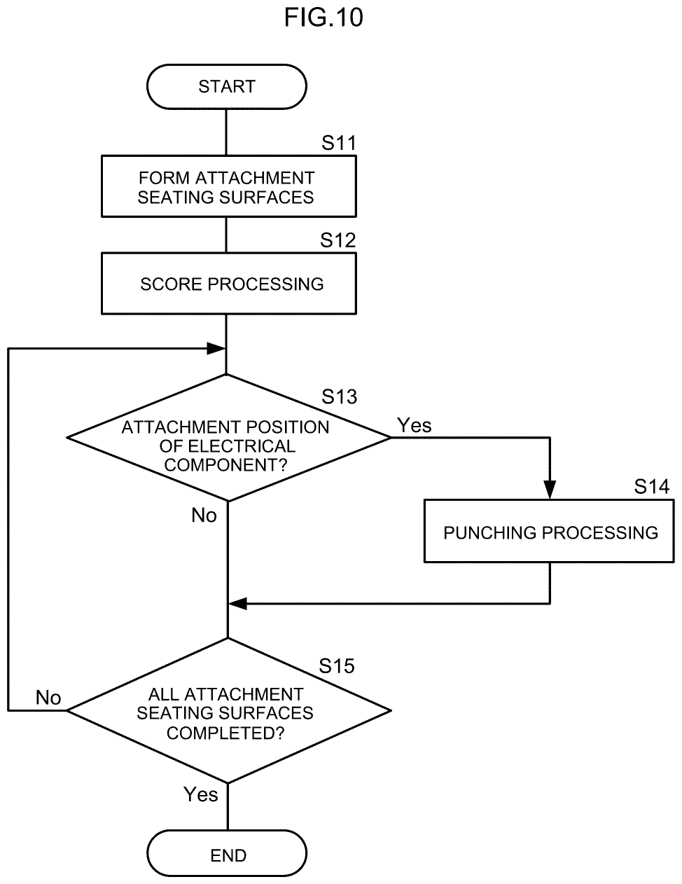

Explanation follows regarding a manufacturing method of the attachment structure 10 of an electrical component of the vehicle 12 according to an exemplary embodiment of the present disclosure. FIG. 10 is a flowchart illustrating a series of manufacturing processes of the attachment structure 10 of an electrical component according to an exemplary embodiment of the present disclosure.

First, at step S11, in the vehicle 12, a seating surface forming machine (not illustrated in the drawings) forms plural attachment seating surfaces 20 at positions P at which electrical components may be attached, and at a height different from a height of the other regions 22. Any kind of processing machine may be used as long as the seating surface forming machine is capable of forming the attachment seating surface 20, and there is no particular limitation thereto.

Next, at step S12, the score processing machine 40 forms score processing holes 30 at plural attachment seating surfaces 20 by performing notch processing along the shapes of the holes to be penetrated.

Next, at step S13, it is determined whether or not each of the plural attachment seating surfaces 20 is at an attachment position of an electrical component in the vehicle 12. This determination is performed, for example, by a CPU of a management device that manages a series of manufacturing processes.

In a case in which an attachment position of an electrical component is determined at step S13 (step S13: YES), at step S14, the punching machine 60 punches out the inside of the score processing hole 30 of the attachment seating surface 20 to form the attachment hole 50, and the processing transitions to step S15.

On the other hand, in a case in which an attachment position of an electrical component is not determined at step S13 (step S13: NO), at step S15, as an example, the CPU determines whether or not determination for all of the attachment seating surfaces 20 of the plural attachment seating surfaces 20 has been completed. In a case in which determination for all the attachment seating surfaces 20 has not been completed (step S15: NO), the processing transitions to step S13.

In a case in which determination for all the attachment seating surfaces 20 has been completed at step S15 (step S15: YES), the series of manufacturing processes is completed.

Explanation follows regarding operation and advantageous effects of the attachment structure 10 of an electrical component of the vehicle 12, and the manufacturing method of the attachment structure 10, in the present exemplary embodiment.

In the attachment structure 10 of an electrical component according to the present exemplary embodiment, the attachment hole 50 is formed in the first attachment seating surface 20B that is provided at a position at which an electrical component is attached at the vehicle 12, and the score processing hole 30, on which notch processing has been performed along the shape of a hole to be penetrated through the second attachment seating surface 20A, is formed. Namely, the attachment hole 50 is formed at a position that is necessary for attachment of an electrical component at the vehicle 12, and the score processing hole 30 is formed at a position that is not necessary for attachment of an electrical component at the vehicle 12. Although notch processing is performed on the score processing hole 30, the score processing hole 30 does not penetrate through, such that covers for closing holes that are not necessary in the vehicle 12 are not necessary. This enables an increase in the installation man-hours and cost required for covers to be suppressed.

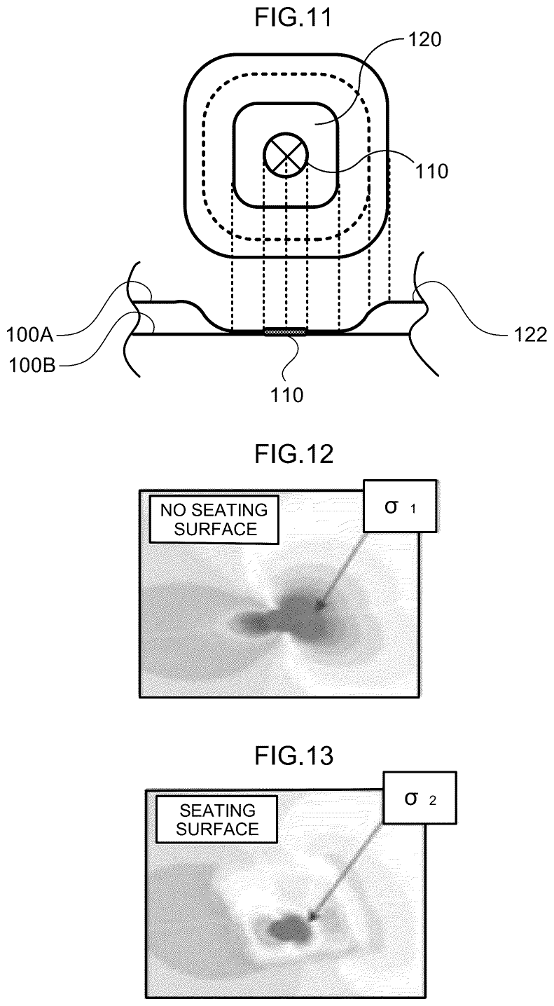

Further, in the attachment structure 10 of an electrical component according to the present exemplary embodiment, the attachment seating surface 20, namely, the first attachment seating surface 20B and the second attachment seating surface 20A are formed at a height different from a height of the other regions 22. Explanation follows regarding a conventional example in which stress concentration is alleviated by a seating surface formed at a height different from a height of other regions. FIG. 11 is a plan view and a side view illustrating an example of a spot welding portion 110 provided at a seating surface 120, FIG. 12 is a diagram illustrating an example of a stress distribution of the spot welding portion 110 in a case in which there is no seating surface 120, and FIG. 13 is a diagram illustrating an example of a stress distribution of the spot welding portion 110 in a case in which there is the seating surface 120.

As illustrated in FIG. 11, in a conventional example, a first sheet metal 100A that is provided with the seating surface 120 and a second sheet metal 100B that is not provided with the seating surface 120 are spot welded together, the spot welding portion 110 is formed at the seating surface 120, and the seating surface 120 is formed at a height different from a height of other regions 122. Specifically, in the same manner as in the above-described attachment seating surface 20 of the present exemplary embodiment, the seating surface 120 is formed lower than the other regions 122. The spot welding portion 110 is formed at a substantially central portion of the seating surface 120. It should be noted that in FIG. 11, for convenience, although the first sheet metal 100A and the second sheet metal 100B are illustrated by solid lines, they actually have thicknesses.

As illustrated in FIG. 12, in a case in which there is no seating surface 120, namely, in a case in which the spot welding portion 110 is provided at the same height as the other regions 122, stress was concentrated at the joint portion, which is a position at which the spot welding portion 110 was formed, as indicated by σ₁. In contrast thereto, as illustrated in FIG. 13, in a case in which there is the seating surface 120, namely, in a case in which the spot welding portion 110 is provided at a height different from a height of the other regions 122, stress was also distributed in the vicinity of the seating surface 120, as illustrated by σ₂. This indicates that in a case in which stress is applied, stress concentration is alleviated by including the seating surface 120 compared to a case in which the seating surface 120 is not included.

On the other hand, as illustrated in FIG. 1 to FIG. 3, there are many positions P at which setting of the score processing hole 30 is being considered, and installation of the score processing hole 30 is also desired with respect to portions that are difficult in terms of strength performance. However, for example, in a case in which the score processing hole 30 is installed at a position to which stress, such as repeated opening and closing operations, is applied, as in the side door 18 in FIG. 3, for example, there are cases of insufficient strength due to the notch 32. In such cases, countermeasures such as making the sheet thickness of the sheet metal used in the panel 12A thicker are necessary, or it is necessary to attach a cover that closes the hole after penetrating the hole in a conventional manner, without performing score processing.

In this regard, in the attachment structure 10 of an electrical component according to the present exemplary embodiment, the score processing hole 30 is formed in a second attachment seating surface 20A (the attachment seating surface 20) that is formed at a height different from a height of the other regions 22. Therefore, stress is dispersed at the second attachment seating surface 20A when stress is applied, such that stress concentration at the score processing hole 30 is alleviated, and stress concentration at the score processing hole 30 and cracking can be prevented from occurring. This enables a decrease in strength at the score processing hole 30 to be suppressed.

Therefore, in the attachment structure 10 of an electrical component according to the present exemplary embodiment, deterioration in strength can be suppressed while suppressing an increase in installation man-hours and cost.

Further, in the attachment structure 10 of an electrical component according to the present exemplary embodiment, the attachment hole 50 is formed by punching out the inside of the shape of the hole on which notch processing has been performed, such that the attachment hole 50 can be formed from the score processing hole 30 as necessary. Namely, the second attachment seating surface 20A can be the first attachment seating surface 20B due to the score processing hole 30 formed at the second attachment seating surface 20A being processed into the attachment hole 50.

Further, in the attachment structure 10 of an electrical component according to the present exemplary embodiment, the first attachment seating surface 20B and the second attachment seating surface 20A are formed at approximately the same height, and therefore, by punching out the inside of the score processing hole 30 that is formed at the second attachment seating surface 20A, an attachment hole 50, with approximately the same level as the attachment hole 50 formed in the first attachment seating surface 20B, can be formed at a position at which the second attachment seating surface 20A is provided, as necessary.

Furthermore, in the attachment structure 10 of an electrical component according to the present exemplary embodiment, the attachment hole 50 and the score processing hole 30 each have at least two different shapes, such that the attachment hole 50 having a shape that corresponds to the type of an electrical component to be attached can be provided.

Further, in the manufacturing method of the attachment structure 10 of an electrical component according to the present exemplary embodiment, the score processing hole 30 on which notch processing has been performed along a shape of the hole to be penetrated is formed in the attachment seating surface 20 that is formed at a height different from a height of the other regions 22. Although notch processing is performed on the score processing hole 30, the score processing hole 30 does not penetrate through, such that a cover for closing a hole, which is not necessary in the vehicle 12, is not necessary. This enables an increase in the installation man-hours and cost required for a cover to be suppressed. Further, since stress is distributed to the attachment seating surface 20, stress concentration at the score processing hole 30 is alleviated, and stress concentration at the score processing hole 30 and cracking can be prevented from occurring. Namely, a decrease in strength at the score processing hole 30 can be suppressed.

### Notes

It should be noted that although the attachment seating surface 20 is square in shape in the above-described exemplary embodiment, the present disclosure is not limited thereto. For example, the shape may be a circular shape or a rectangular shape, and there is no particular limitation imposed on the shape. Similarly, the shapes of the score processing hole 30 and the attachment hole 50 are not limited to a circular shape, and may be any shape.

Further, in the above-described exemplary embodiment, the score processing hole 30 and the attachment hole 50 each have at least two shapes that differ in size and shape in accordance with the position P at which the attachment seating surface 20 is installed; however, the present disclosure is not limited thereto. For example, only one of the score processing hole 30 or the attachment hole 50 may have two or more different shapes. Further, both the score processing hole 30 and the attachment hole 50 may have the same shape only.

Further, in the above-described exemplary embodiment, the first attachment seating surface 20B is formed by punching out the inside of the score processing hole 30 that is formed in the second attachment seating surface 20A and penetrating through the attachment hole 50; however, the present disclosure is not limited thereto. The attachment hole 50 may be formed in the attachment seating surface 20 that is formed at a position in advance at which the attachment hole 50 is required at the vehicle 12 by a known hole processing technique, and the attachment seating surface 20 provided with the attachment hole 50 may be the first attachment seating surface 20B. In such a case, the first attachment seating surface 20B and the second attachment seating surface 20A may be formed at different heights.

Further, the configuration of the present disclosure is not limited to the above-described exemplary embodiment, and the configuration can be changed, as appropriate, as long as the problem can be solved.

What is claimed is:

1. An attachment structure of an electrical component, comprising:
a plurality of first attachment seating surfaces that are provided at positions at which the electrical component is attached at a vehicle, each of the plurality of first attachment seating surfaces formed with an attachment hole; and
a plurality of second attachment seating surfaces, each of the plurality of second attachment seating surfaces is formed with a score processing hole on which notch processing has been performed along a shape of a hole to be penetrated,
wherein the plurality of first attachment seating surfaces and the plurality of second attachment seating surfaces are formed at heights different from a height of other regions.

2. The attachment structure of an electrical component according to claim 1, wherein:
the attachment hole is formed by punching out an inside of the score processing hole on which notch processing has been performed along a shape of a hole to be penetrated.

3. The attachment structure of an electrical component according to claim 1, wherein:
the plurality of first attachment seating surfaces and the plurality of second attachment seating surfaces are formed at substantially a same height.

4. The attachment structure of an electrical component according to claim 1, wherein:
attachment holes formed at the plurality of first attachment seating surfaces, score processing holes formed at the plurality of second attachment seating surfaces, or any combination thereof, have at least two different shapes.

5. A method of manufacturing an attachment structure, the method comprising:
forming a plurality of attachment seating surfaces at positions at which an electrical component may be attached at a vehicle, at a height different from a height of other regions;
forming, at each of the plurality of attachment seating surfaces, a score processing hole on which notch processing has been performed along a shape of a hole to be penetrated; and
forming attachment holes, by punching out an inside of the score processing holes, at the score processing holes provided at positions at which attachment of the electrical component has been determined.
